(19) United States
(12) Patent Application Publication
(10) Pub. No.: US 2015/0145366 A1
(43) Pub. Date: May 28, 2015

(54) ROTOR HAVING RESIN HOLES FOR FILLING RESIN AND METHOD OF PRODUCING A ROTOR

(71) Applicant: FANUC CORPORATION, Yamanashi (JP)

(72) Inventors: Koudai Akashi, Yamanashi (JP); Hidetoshi Uematsu, Yamanashi (JP); Makoto Funakubo, Yamanashi (JP)

(21) Appl. No.: 14/548,666

(22) Filed: Nov. 20, 2014

(30) Foreign Application Priority Data
Nov. 26, 2013 (JP) 2013-243970

(51) Int. Cl. H02K 1/28; H02K 15/02; H02K 1/27

(52) U.S. Cl. CPC H02K 1/28; H02K 1/276; H02K 15/024
USPC 310/156.08; 29/598

(57) ABSTRACT

A rotor which can raise the axial direction strength near the end edges outside of the rotor core in the radial direction. The rotor comprises a shaft, a rotor core which has a plurality of magnetic steel sheets and is fastened to the shaft, and a plurality of magnets which are arranged inside of the rotor core. The rotor core has a center hole which holds the shaft, a plurality of magnet holes which are arranged at the outside of the center hole in the radial direction and hold magnets, resin holes which are arranged at the outsides of the magnet holes in the radial direction and which run through the rotor core in the axial direction, and rotor core fastening members which include first resin parts which are filled inside the resin holes.

### BACKGROUND OF THE INVENTION

1. Field of the Invention

The present invention relates to a rotor which has resin holes for filling a resin and a method of production of a rotor.

2. Description of the Related Art

Known in the art is a rotor which is provided with a rotor core which is comprised of magnetic steel sheets stacked in the axial direction wherein holes which run through the rotor core in the axial direction are provided at positions inside in the radial direction from magnets which are arranged at the inside of the rotor core and the holes are filled with resin so as to increase the strength of the rotor core in the axial direction (for example, see Japanese Patent Publication No. 2000-134836A and Japanese Patent Publication No. 2004-328970A).

In stacked magnetic steel sheets, the radially outside ends thereof tend to most easily deform when external force etc. is applied. According to the prior art, it was not possible to sufficiently raise the axial direction strength near the radially outer edges of the rotor core, and therefore the radially outside ends of the stacked steel sheets constituting the rotor core may easily be deformed due to the effect of external force etc.

### SUMMARY OF THE INVENTION

In one aspect of the present invention, the rotor comprises a shaft; a rotor core fastened to the shaft and including a plurality of magnetic steel sheets stacked in an axial direction of the shaft; and a plurality of magnets arranged inside of the rotor core. The rotor core includes a center hole which receives the shaft therein; a plurality of magnet holes arranged radially outside of the center hole, each of the magnet holes receiving the magnet; resin holes arranged radially outside of the magnet hole, and extending through the rotor core in the axial direction; and rotor core fastening members including a first resin part filled in the resin hole.

A plurality of the resin holes may be formed in a region between the magnet hole and a part of the outer circumferential surface of the rotor core located radially outside of the magnet hole. The resin hole may be arranged at a position where the distance between the magnet hole and a part of the outer circumferential surface of the rotor core located radially outside of the magnet hole becomes greatest. The rotor core fastening members may include engagement parts provided at the both ends of the first resin part in the axial direction so as to project out from the end faces of the rotor core in the axial direction, and engaging the end faces of the rotor core in the axial direction.

The rotor core fastening member may include a connecting part connecting the first resin part filled in a first resin hole and other first resin part filled in a second resin hole adjoining the first resin hole in the circumferential direction, on the end face of the rotor core in the axial direction.

The connecting part may extend in the circumferential direction so as to cover the radially outside edge of the end face of the rotor core in the axial direction. The connecting part may extend over the entire circumference of the rotor core. The rotor core fastening member may further include a second resin part filled in the gap formed between the magnet and the magnet hole. The second resin part may be made of a same material as the first resin part. The rotor core fastening member may be made of a glass fiber-reinforced resin.

In another aspect of the present invention, the method of producing a rotor comprises steps of fastening a rotor core to a shaft, wherein the rotor core is comprised of a plurality of magnetic steel sheets stacked in an axial direction of the rotor, and includes a center hole, a magnet hole arranged radially outside of the center hole, and a resin hole arranged radially outside of the magnet hole, wherein the rotor core is fastened to the shaft by fitting the shaft into the center hole; inserting a magnet into the magnet hole of the rotor core, and pouring a resin into the resin hole of the rotor core and the gap formed between the magnet and the magnet hole.

The method may further comprises a step of introducing a resin on the end face of the rotor core in the axial direction after the step of pouring the resin, so as to connect the resin filled in a first resin hole and other resin filled in a second resin hole which adjoins the first resin hole in the circumferential direction, on the end faces of the rotor core in the axial direction.

### BRIEF DESCRIPTION OF THE DRAWINGS

The above and other objects, features, and advantages of the present invention will become further clearer by the following description of the preferred embodiments given while referring to the attached drawings, in which

FIG. 1A is a perspective view of a rotor according to an embodiment of the present invention,

FIG. 1B is a side cross-sectional view of the rotor shown in FIG. 1A,

FIG. 2A is a perspective view omitting the resin parts and magnets from the rotor shown in FIG. 1A,

FIG. 2B is a view seen from an arrow “b” in FIG. 2A,

FIG. 3A is a perspective view of a rotor core according to another embodiment of the present invention,

FIG. 3B is a view seen from an arrow “b” in FIG. 3A,

FIG. 4A is a perspective view of a rotor according to yet another embodiment of the present invention,

FIG. 4B is a view seen from an arrow “b” in FIG. 4A, and

FIG. 5 is a flow chart of a method of producing a rotor, according to an embodiment of the present invention.

### DETAILED DESCRIPTION

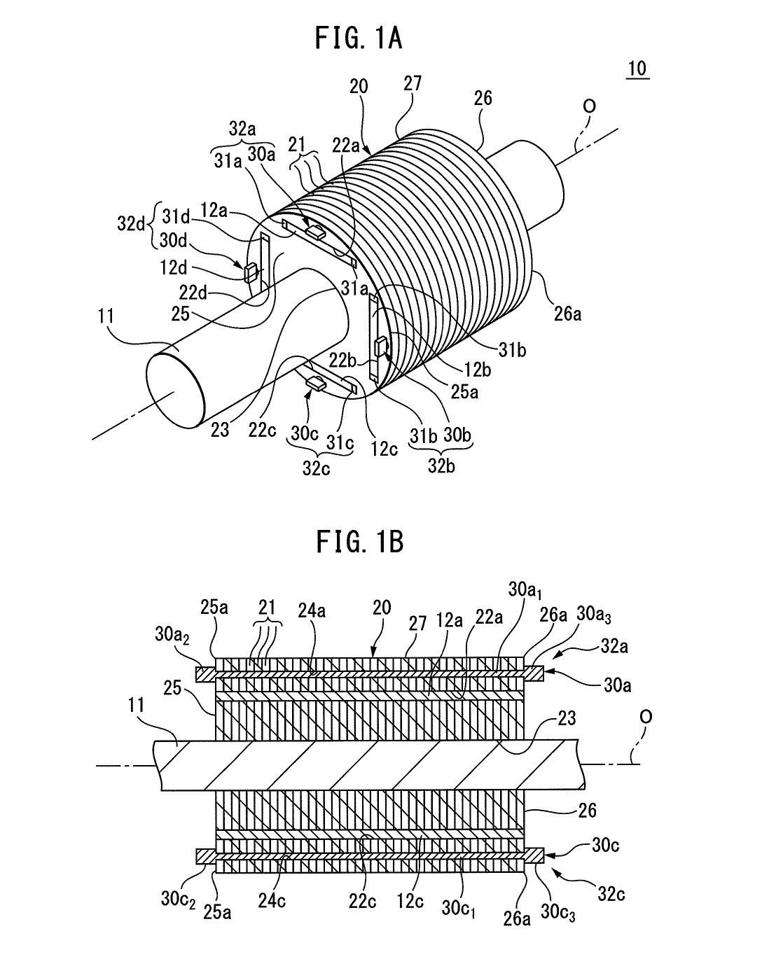

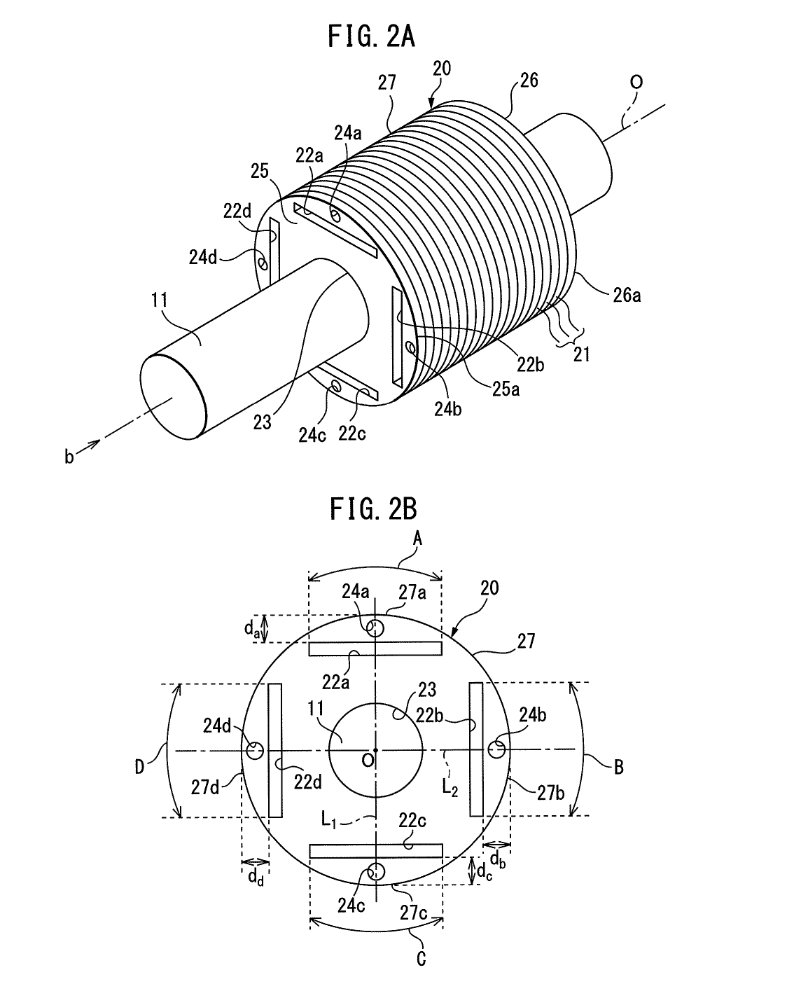

Below, embodiments of the present invention will be explained in detail based on the drawings. First, referring to FIG. 1A to FIG. 2B, a rotor 10 according to an embodiment of the present invention will be explained. Note that, in the following explanation, the “axial direction” indicates a direction along a center axis O of a later explained shaft 11, the “radial direction” indicates a radial direction of a circle which has a center on a center axis O of the shaft 11 and which is perpendicular to the center axis O, and the “circumferential direction” indicates a direction along a circumference of the circle. Further, the “front in the axial direction (axially frontward)” indicates the left direction in FIG. 1B.

The rotor 10 includes a columnar shaft 11 having a center axis O; a rotor core 20 fixed at the outside of the shaft 11 in the radial direction; and a plurality of magnets 12a, 12b, 12c, and 12d which are arranged at the inside of the rotor core 20. The magnets 12a, 12b, 12c, and 12d are rectangular plate members, each of which has a predetermined length, width, and thickness. Note that, regarding the length, width, and thickness, when using the magnet 12a shown in FIG. 1B as an example, the “length direction” indicates the direction along the axial direction, the “width direction” indicates the front-back direction of FIG. 1B, and the “thickness direction” indicates the up-down direction of FIG. 1B. In the present embodiment, a total of four magnets 12a, 12b, 12c, and 12d are arranged in the circumferential direction.

The rotor core 20 is comprised of a plurality of magnetic steel sheets 21 stacked in the axial direction. The rotor core 20 includes an end face 25 at the front in the axial direction (axially front end face 25); an end face 26 at the rear in the axial direction (axially rear end face 26), and a cylindrical outer circumferential surface 27 which extends in the axial direction from the edge 25a of the end face 25 outside in the radial direction (the radially outside edge 25a of the end face 25) to the edge 26a of the end face 26 outside in the radial direction (the radially outside edge 26a of the end face 26). The rotor core 20 includes a center hole 23 which receives a shaft 11 therein; a plurality of magnet holes 22a, 22b, 22c, and 22d which respectively receive the magnets 12a, 12b, 12c, and 12d; and a plurality of the resin holes 24a, 24b, 24c, and 24d, each of which extends through the rotor core 20 in the axial direction.

The magnet holes 22a, 22b, 22c, and 22d are provided radially outside of the center hole 23 and are arranged at about 90° intervals in the circumferential direction so as to be rotationally symmetric about the axis O. Each of the magnet holes 22a, 22b, 22c, and 22d has a square shape corresponding to the magnets 12a, 12b, 12c, and 12d, and extends through the rotor core 20 in the axial direction. More specifically, the magnet hole 22a has a width somewhat larger than the width of the magnet 12a. Therefore, when the magnet 12a is received in the magnet hole 22a, gaps are formed at the both ends of the magnet hole 22a in the width direction.

In the same way, the magnet holes 22b, 22c, and 22d also have widths somewhat larger than the widths of the magnets 12b, 12c, and 12d, respectively. Therefore, when the magnets 12b, 12c, and 12d are respectively received in the magnet holes 22b, 22c, and 22d, gaps are formed at the both ends of each of the magnet holes 22b, 22c, and 22d in the width direction.

The resin holes 24a, 24b, 24c, and 24d are approximately columnar through holes which extend through the rotor core 20 in the axial direction, and are respectively provided radially outside of the magnet holes 22a, 22b, 22c, and 22d. More specifically, the resin hole 24a is formed in the region between the magnet hole 22a and a part 27a of the outer circumferential surface 27 of the rotor core 20 located radially outside of the magnet hole 22a (i.e., a part of the outer circumferential surface 27 within range A shown in FIG. 2B).

In the present embodiment, the resin hole 24a is arranged at a position where the distance between the magnet hole 22a and the part 27a of the outer circumferential surface 27 becomes the greatest. More specifically, as shown in FIG. 2B, the magnet hole 22a is arranged so that a line L₁ radially extending from the center axis O in the top-bottom direction in FIG. 2B passes through the center of the magnet hole 22a in the width direction.

In the present embodiment, the position where the distance between the magnet hole 22a and the part 27a of the outer circumferential surface 27 becomes the greatest is on the line L₁. The resin hole 24a is provided between the magnet hole 22a and the part 27a so that its center is positioned on the line L₁. The distance between the magnet hole 22a and the part 27a at this position is shown as distance dₐ in FIG. 2B.

In the same way, the resin hole 24b is formed in the region between the magnet hole 22b and a part 27b of the outer circumferential surface 27 of the rotor core 20 located radially outside of the magnet hole 22b (i.e., a part of the outer circumferential surface 27 within range B shown in FIG. 2B). As shown in FIG. 2B, the magnet hole 22b is arranged so that a line L₂ radially extending from the center axis O in the left-right direction in FIG. 2B passes through the center of the magnet hole 22b in the width direction.

Therefore, as shown as distance d_{b} in FIG. 2B, the distance between the magnet hole 22b and the part 27b of the outer circumferential surface 27 becomes the greatest at a position on the line L₂. The resin hole 24b is provided between the magnet hole 22b and the part 27b so that its center is arranged on the line L₂.

In the same way, the resin hole 24c is formed in the region between the magnet hole 22c and a part 27c of the outer circumferential surface 27 of the rotor core 20 located radially outside of the magnet hole 22c (i.e., a part of the outer circumferential surface 27 within range C shown in FIG. 2B). In the same way as the magnet hole 22a, the magnet hole 22c is arranged so that the line L₁ passes through the center of the magnet hole 22c in the width direction.

Therefore, as shown as the distance d_{c} in FIG. 2B, the distance between the magnet hole 22c and the part 27c of the outer circumferential surface 27 becomes the greatest at a position on the line L₁. The resin hole 24c is provided between the magnet hole 22c and the part 27c so that its center is arranged on the line L₁.

In the same way, the resin hole 24d is formed in the region between the magnet hole 22d and a part 27d of the outer circumferential surface 27 of the rotor core 20 located radially outside of the magnet hole 22d (i.e., a part of the outer circumferential surface 27 within range D shown in FIG. 2B). In the same way as the magnet hole 22b, the magnet hole 22d is arranged so that the line L₂ passes through the center of the magnet hole 22d in the width direction.

Therefore, as shown as the distance d_{d} in FIG. 2B, the distance between the magnet hole 22d and the part 27d of the outer circumferential surface 27 becomes the greatest at a position on the line L₂. The resin hole 24d is provided between the magnet hole 22d and the part 27d so that its center is arranged on the line L₂.

The rotor core 20 includes rotor core fastening members 32a, 32b, 32c, and 32d for fastening the rotor core 20 from the axial direction so as to increase the axial direction strength of the rotor core 20. The rotor core fastening members 32a, 32b, 32c, and 32d are made of same resin material, such as a glass fiber-reinforced resin or carbon fiber-reinforced resin.

Specifically, the rotor core fastening member 32a includes a first resin part 30a and a second resin part 31a. The first resin part 30a includes a main part 30a₁ which is filled in the resin hole 24a. The first engagement part 30a₂ projecting out from the end face 25 of the rotor core 20 toward the axially frontward is formed at the axially front end of the main part 30a₁. The first engagement part 30a₂ has an outer shape larger than the diameter of the resin hole 24a. The first engagement part 30a₂ can engage the end face 25 of the rotor core 20 so as to fasten the rotor core 20 from the front side in the axial direction.

On the other hand, the second engagement part 30a₃ projecting out from the end face 26 of the rotor core 20 toward the axially rearward is formed at the axially rear end of the main part 30a₁. The second engagement part 30a₃ has an outer shape larger than the diameter of the resin hole 24a and can engage the end face 26 of the rotor core 20 so as to fasten the rotor core 20 from the axially rear side. In this way, the first resin part 30a can increase the axial direction strength of the rotor core 20 by holding the rotor core 20 from the front and back in the axial direction by the first engagement part 30a₂ and the second engagement part 30a₃.

The second resin part 31a is filled in the gaps formed at the both ends of the magnet hole 22a in the width direction when the magnet 12a is inserted into the magnet hole 22a. The second resin part 31a extends over the entire length of the rotor core 20 in the axial direction, and can increase the strength in the axial direction of the rotor core 20 along with the first resin part 30a.

Similarly, the rotor core fastening member 32b includes a first resin part 30b and a second resin part 31b. The first resin part 30b includes a main part (not shown) arranged in the resin hole 24b. A first engagement part and a second engagement part are respectively provided at the axially front end and axially rear end of the main part. Further, the second resin part 31b is filled in the gaps formed at the both ends of the magnet hole 22b in the width direction when the magnet 12b is inserted into the magnet hole 22b.

Similarly, the rotor core fastening member 32c includes a first resin part 30c and a second resin part 31c. The first resin part 30c includes a main part 30c₁ arranged in the resin hole 24c. A first engagement part 30c₂ and a second engagement part 30c₃ are respectively provided at the axially front end and axially rear end of the main part 30c₁. Further, the second resin part 31c is filled in the gaps formed at the both ends of the magnet hole 22c in the width direction when the magnet 12c is inserted into the magnet hole 22c.

Similarly, the rotor core fastening member 32d includes a first resin part 30d and a second resin part 31d. The first resin part 30d includes a main part (not shown) arranged in the resin hole 24d. A first engagement part and a second engagement part are respectively provided at the axially front end and axially rear end of the main part. Further, the second resin part 31d is filled in the gaps formed at the both ends of the magnet hole 22d in the width direction when the magnet 12d is inserted into the magnet hole 22d.

According to the present embodiment, the resin holes 24a, 24b, 24c, and 24d are respectively formed in the regions axially outside of the magnet holes 22a, 22b, 22c, and 22d, as stated above. Further, first resin parts 30a, 30b, 30c, and 30d capable of increasing the axial direction strength of the rotor core 20 are respectively filled in these resin holes 24a, 24b, 24c, and 24d. Due to this configuration, it is possible to increase the axial direction strength at the region of the rotor core 20 near the outer circumferential surface 27. Therefore, the magnetic steel sheets 21 constituting the rotor core 20 can be prevented from deforming at the radially outer end thereof.

Further, according to the present embodiment, the resin holes 24a, 24b, 24c, and 24d are respectively arranged at positions where the distances between the magnet holes 22a, 22b, 22c, and 22d and the parts 27a, 27b, 27c, and 27d of the outer circumferential surface 27 of the rotor core 20 become the greatest, as stated above. Due to this configuration, it is possible to increase the axial direction strength at the position where the radially outer ends of the magnetic steel sheets 21 tend to most easily deform. Therefore, the end parts of the magnetic steel sheets 21 can be more effectively prevented from deforming.

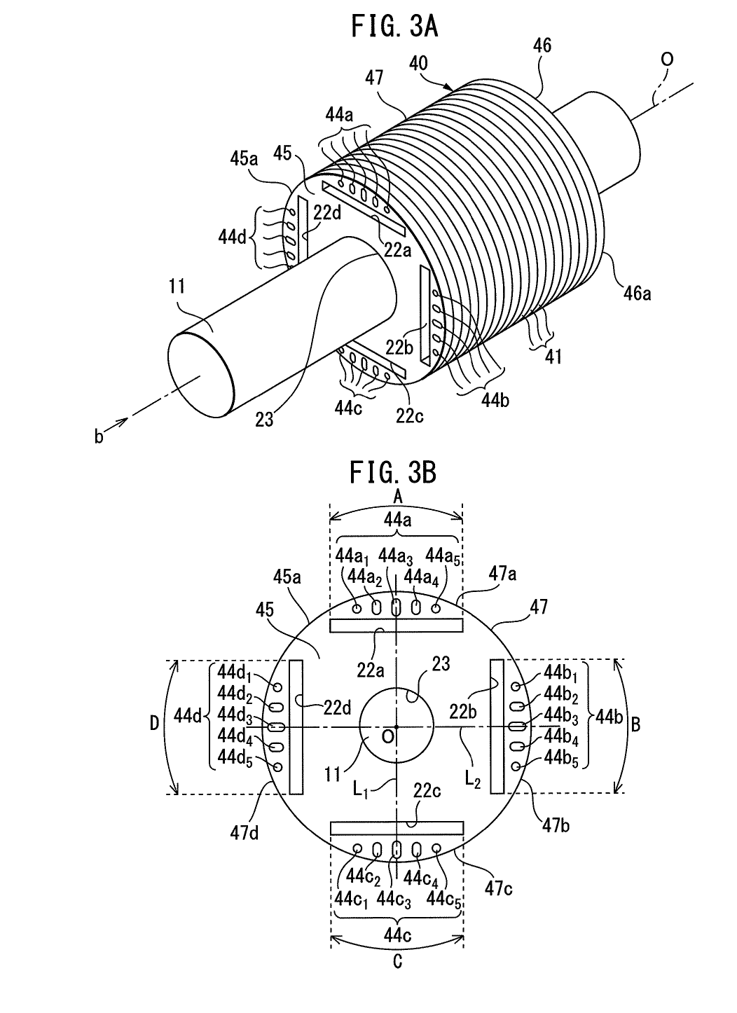

Next, referring to FIG. 3A and FIG. 3B, a rotor core 40 according to another embodiment of the present invention will be explained. Note that, elements similar to those of the above-mentioned embodiment will be assigned the same numeral references, and detailed explanations thereof will be omitted. The rotor core 40 is comprised of a plurality of magnetic steel sheets 41 stacked in the axial direction, as the above rotor core 20.

The rotor core 40 has an axially front end face 45, an axially rear end face 46, and a cylindrical outer circumferential surface 47 extending from the radially outer edge 45a of the end face 45 to the radially outer edge 46a of the end face 46. The rotor core 40 includes a center hole 23, magnet holes 22a, 22b, 22c, and 22d, which are similar to those in the above-mentioned embodiment; and a plurality of the resin holes 44a, 44b, 44c, and 44d extending through the rotor core 40 in the axial direction.

The resin holes 44a include five holes 44a₁, 44a₂, 44a₃, 44a₄ and 44a₅, and are formed in a region between the magnet hole 22a and a part 47a of the outer circumferential surface 47 of the rotor core 40 located radially outside of the magnet hole 22a (i.e., a part of the outer circumferential surface 47 within range A shown in FIG. 3B). The holes 44a₂, 44a₃, and 44a₄ out of the holes 44a₁, 44a₂, 44a₃, 44a₄, and 44a₅ of the resin holes 44a are approximately oval shaped elongated holes.

Further, the hole 44a₃, which is arranged at the center in the circumferential direction among these holes, is arranged so that its center is on the line L₁.

In the same way, the resin holes 44b include five holes 44b₁, 44b₂, 44b₃, 44b₄ and 44b₅, and are formed in a region between the magnet hole 22b and a part 47b of the outer circumferential surface 47 of the rotor core 40 located radially outside of the magnet hole 22b (i.e., a part of the outer circumferential surface 47 within range B shown in FIG. 3B). Further, the hole 44b₃, which is arranged at the center in the circumferential direction among the holes 44b₁, 44b₂, 44b₃, 44b₄, and 44b₅ of the resin holes 44b, is arranged so that its center is on the line L₂.

In the same way, the resin holes 44c include five holes 44c₁, 44c₂, 44c₃, 44c₄ and 44c₅, and are formed in a region between the magnet hole 22c and a part 47c of the outer circumferential surface 47 of the rotor core 40 located radially outside of the magnet hole 22c (i.e., a part of the outer circumferential surface 47 within range C shown in FIG. 3B). Further, the hole 44c₃, which is arranged at the center in the circumferential direction among the holes 44c₁, 44c₂, 44c₃, 44c₄, and 44c₅ of the resin holes 44c, is arranged so that its center is on the line L₁.

In the same way, the resin holes 44d include five holes 44d₁, 44d₂, 44d₃, 44d₄ and 44d₅, and are formed in a region between the magnet hole 22d and a part 47d of the outer circumferential surface 47 of the rotor core 40 located radially outside of the magnet hole 22d (i.e., a part of the outer circumferential surface 47 within range D shown in FIG. 3B). Further, the hole 44d₃, which is arranged at the center in the circumferential direction among the holes 44d₁, 44d₂, 44d₃, 44d₄, and 44d₅ of the resin holes 44d, is arranged so that its center is on the line L₂.

When the rotor core 40 according to the present embodiment is assembled as shown in FIG. 1A, the rotor core 40 is provided with the rotor core fastening members which include the first resin parts filled in the resin holes 44a, 44b, 44c, and 44d and the second resin parts filled in the gaps formed at the both ends of the magnet holes 22a, 22b, 22c, and 22d in the width direction.

According to the present embodiment, the resin holes 44a, 44b, 44c, and 44d, each of which includes the plurality of holes, are respectively formed in the regions between the magnet holes 22a, 22b, 22c, and 22d and the parts 47a, 47b, 47c, and 47d of the outer circumferential surface 47. Due to this configuration, it is possible to more effectively increase the axial direction strength of the rotor core 40 near the outer circumferential surface 47. Therefore, the radially outer ends of the magnetic steel sheets 41 constituting the rotor core 40 can be more effectively prevented from deforming.

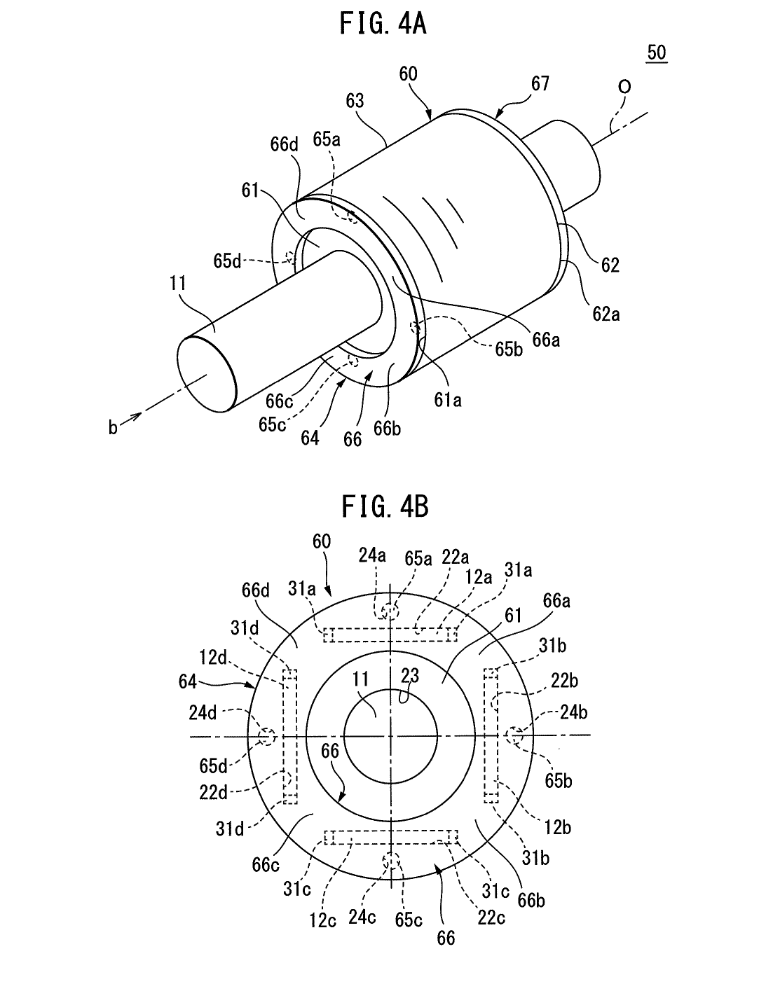

Next, referring to FIG. 4A and FIG. 4B, the rotor 50 according to yet another embodiment of the present invention will be explained. Note that, elements similar to those of the above-mentioned embodiment will be assigned the same numeral references, and detailed explanations thereof will be omitted. The rotor 50 includes a shaft 11; a rotor core 60 fastened to the radially outside of the shaft 11; and a plurality of magnets 12a, 12b, 12c, and 12d arranged inside of the rotor core 60.

The rotor core 60 is comprised of a plurality of magnetic steel sheets stacked in the axial direction, as the above-mentioned embodiment. The rotor core 60 has an axially front end face 61; an axially rear end face 62, and a cylindrical outer circumferential surface 63 extending from the radially outer edge 61a of the end face 61 to the radially outer edge 62a of the end face 62. The rotor core 60 includes a center hole 23; magnet holes 22a, 22b, 22c, and 22d; resin holes 24a, 24b, 24c, and 24d; and a rotor core fastening member 64 for fastening the rotor core 60 from the axial direction so as to increase the axial direction strength of the rotor core 60.

The rotor core fastening member 64 according to the present embodiment includes first resin parts 65a, 65b, 65c, and 65d which are respectively filled in the resin holes 24a, 24b, 24c, and 24d; a first connecting part 66 arranged on the axially front end face 61 of the rotor core 60; and a second connecting part 67 arranged on the axially rear end face 62 of the rotor core 60.

The first connecting part 66 extends in the circumferential direction over the entire circumference of the rotor core 60 so as to connect the axially front ends of the first resin parts 65a, 65b, 65c, and 65d each other, on the end face 61 of the rotor core 60. The first connecting part 66 is arranged so as to cover the edge 61a of the end face 61 from the axially front side.

More specifically, the first connecting part 66 includes an arc part 66a which connects the first resin part 65a filled in the resin hole 24a and the first resin part 65b filled in the resin hole 24b which adjoins the resin hole 24a in the circumferential direction. In the same way, the first connecting part 66 includes an arc part 66b which connects the first resin part 65b filled in the resin hole 24b and the first resin part 65c filled in the resin hole 24c which adjoins the resin hole 24b in the circumferential direction.

Further, the first connecting part 66 includes an arc part 66c which connects the first resin part 65c filled in the resin hole 24c and the first resin part 65d filled in the resin hole 24d which adjoins the resin hole 24c in the circumferential direction. Further, the first connecting part 66 includes an arc part 66d which connects the first resin part 65d filled in the resin hole 24d and the first resin part 65a filled in the resin hole 24a which adjoins the resin hole 24d in the circumferential direction.

The second connecting part 67 has the same configuration as the first connecting part 66. Specifically, the second connecting part 67 extends in the circumferential direction over the entire circumference of the rotor core 60 so as to connect the axially rear ends of the first resin parts 65a, 65b, 65c, and 65d each other, on the end face 62 of the rotor core 60.

The second connecting part 67 is arranged so as to cover the edge 62a of the end face 62 from the axially rear side. The second connecting part 67 has arc parts which mutually connect the first resin part 65a and first resin part 65b, the first resin part 65b and first resin part 65c, the first resin part 65c and first resin part 65d, and the first resin part 65d and first resin part 65a.

Similar to the above-mentioned embodiment, the rotor core fastening member 64 includes the second resin parts 31a, 31b, 31c, and 31d. The second resin parts 31a, 31b, 31c, and 31d are respectively filled in the gaps which are formed at the both ends of the magnet holes 22a, 22b, 22c, and 22d in the width direction when the magnets 12a, 12b, 12c, and 12d are inserted into the magnet holes 22a, 22b, 22c, and 22d, respectively. The rotor core fastening members 64 is made of e.g. a glass fiber-reinforced resin or carbon fiber-reinforced resin.

According to the present embodiment, the first connecting part 66 and the second connecting part 67 respectively hold the end faces 61 and 62 of the rotor core 60 from the axially front side and axially rear side, so as to cover the edges 61a and 62a. Due to this configuration, it is possible to increase the axial direction strength of the radially outer end of the rotor core 60, more effectively. Therefore, the magnetic steel sheets forming the rotor core 60 can be more effectively prevented from deforming at the radially outer end thereof.

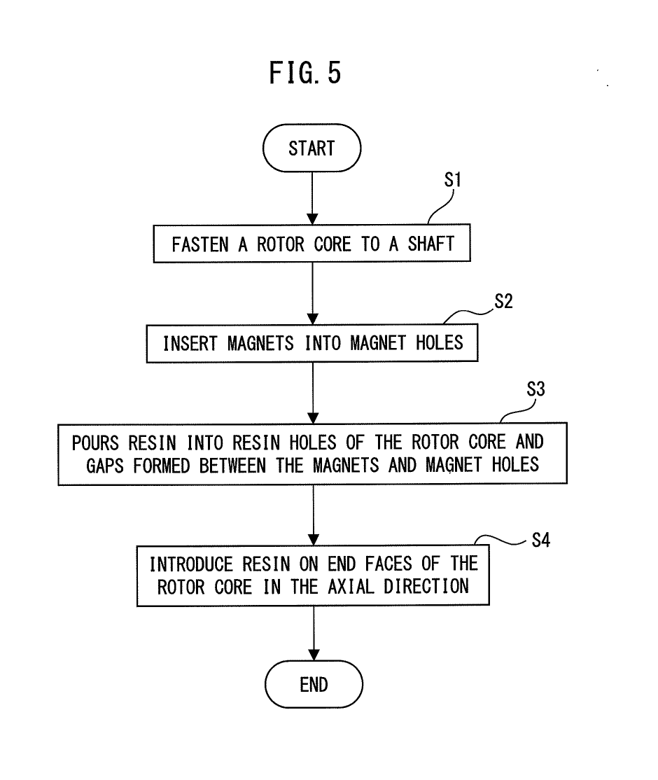

Next, referring to FIG. 5, a method of producing a rotor, according to an embodiment of the present invention will be explained. At step S1, the user fastens a rotor core to a shaft. For example, when producing a rotor core 60 shown in FIG. 4A, the user stacks a plurality of magnetic steel sheets in the axial direction so as to produce the rotor core 60 which includes a center hole 23; magnet holes 22a, 22b, 22c, and 22d; and resin holes 24a, 24b, 24c, and 24d, and then fastens the rotor core 60 radially outside of the shaft 11 by fitting the shaft 11 into the center hole 23.

At step S2, the user inserts magnets into magnet holes provided at the rotor core. Specifically, the user inserts magnets 12a, 12b, 12c, and 12d into the magnet holes 22a, 22b, 22c, and 24d of the rotor core 60, respectively. At this time, the gaps are formed between the magnets 12a, 12b, 12c, and 12d and magnet holes 22a, 22b, 22c, and 22d.

At step S3, the user pours resin into the resin holes of the rotor core and the gaps formed between the magnets and magnet holes. Specifically, the user pours resin into the resin holes 24a, 24b, 24c, and 24d of the rotor core 60 and the gaps formed between the magnets 12a, 12b, 12c, and 12d and the magnet holes 22a, 22b, 22c, and 22d.

As a result, the first resin parts 65a, 65b, 65c, and 65d and the second resin parts 31a, 31b, 31c, and 31d are formed. At this step S3, from the viewpoint of improvement of work efficiency, the user may simultaneously pour resin into the resin holes 24a, 24b, 24c, and 24d and the gaps formed at the magnet holes 22a, 22b, 22c, and 22d.

At step S4, the user introduces resin on the end faces of the rotor core in the axial direction so as to form the connecting parts. Specifically, the user introduces resin on the end face 61 of the rotor core 60 so as to connect the first resin part 65a and first resin part 65b, the first resin part 65b and first resin part 65c, the first resin part 65c and first resin part 65d, and the first resin part 65d and first resin part 65a.

At this time, the user introduces resin on the end face 61 of the rotor core 60 so as to cover the radially outer edge 61a of the end face 61 of the rotor core 60 from the axially front side. As a result, the first connecting part 66 with the four arc parts is formed on the end face 61 of the rotor core 60.

Similarly, the user introduces resin on the end face 62 of the rotor core 60 so as to connect the first resin part 65a and first resin part 65b, the first resin part 65b and first resin part 65c, the first resin part 65c and first resin part 65d, and the first resin part 65d and first resin part 65a.

At this time, the user introduces resin on the end face 62 of the rotor core 60 so as to cover the radially outer edge 62a of the end face 62 of the rotor core 60 from the axially rear side. As a result, the second connecting part 67 with the four arc parts is formed on the end face 62 of the rotor core 60.

Note that, in the above-mentioned embodiment, the case, wherein the resin hole is arranged at the position where the distance between the magnet hole and the part of the outer circumference surface of the rotor core located radially outside of the magnet hole becomes the greatest, is explained. However, the invention is not limited to this. The resin hole may be formed at any position so long as in region radially outside of the magnet hole. Further, the resin holes 24a, 24b, 24c, and 24d shown in FIG. 4B may also be formed as resin holes comprised of pluralities of holes like the resin holes 44a, 44b, 44c, and 44d shown in FIG. 3B.

As explained above, according to the present invention, the resin holes which are arranged in the regions at the outsides of the magnet holes in the radial direction are filled with first resin parts which can raise the axial direction strength of the rotor core. Due to the first resin parts, the axial direction strength of the regions of the rotor core close to the outer circumferential surface can be raised. Due to this, the magnetic steel sheets which form the rotor core can be prevented from ending up deforming at the end parts at the outside in the axial direction.

Above, the present invention was explained through embodiments of the present invention, but the above embodiments do not limit the invention relating to the claims. Further, all combinations of features which were explained in the embodiment are not necessarily essential for the invention. Further, the above embodiments can be changed or improved in various ways as clear to a person skilled in the art. Such changed or improved embodiments are also included in the technical scope of the present invention as clear from the claim language.

Further, it should be noted that the operations, routines, steps, stages, and other processing in the apparatus, system, program, and method in the claims, specification, and drawings, unless particularly clearly indicated by “before”, “in advance of”, etc. or the output of prior processing being used for later processing, can be realized in any order. In the flow of operations in the claims, specification, and drawings, even if explained using “first”, “next”, etc. for convenience, this does not mean the execution in this order is essential.

1. A rotor comprising
a shaft;
a rotor core fastened to the shaft and including a plurality of magnetic steel sheets stacked in an axial direction of the shaft; and
a plurality of magnets arranged inside of the rotor core, wherein
the rotor core includes:
a center hole receiving the shaft therein;
a plurality of magnet holes arranged radially outside of the center hole, each of the magnet holes receiving the magnet therein;
a resin hole arranged radially outside of the magnet hole, and extending through the rotor core in the axial direction; and
a rotor core fastening member including a first resin part filled in the resin hole.

2. The rotor according to claim 1, wherein a plurality of the resin holes are formed in a region between the magnet hole and a part of an outer circumferential surface of the rotor core located radially outside of the magnet hole.

3. The rotor according to claim 1, wherein the resin hole is arranged at a position where the distance between the magnet hole and a part of an outer circumferential surface of the rotor core located radially outside of the magnet hole becomes greatest.

4. The rotor according to claim 1, wherein the rotor core fastening member includes engagement parts provided at both ends of the first resin part in the axial direction so as to project out from end faces of the rotor core in the axial direction, and engaging the end faces of the rotor core in the axial direction.

5. The rotor according to claim 1, wherein the rotor core fastening member includes a connecting part connecting the first resin part filled in a first resin hole and other first resin part filled in a second resin hole adjoining the first resin hole in the circumferential direction, on an end face of the rotor core in the axial direction.

6. The rotor according to claim 5, wherein the connecting part extends in a circumferential direction so as to cover a radially outside edge of the end face of the rotor core in the axial direction.

7. The rotor according to claim 5, wherein the connecting part extends over the entire circumference of the rotor core.

8. The rotor according to claim 1, wherein
the rotor core fastening member further includes a second resin part filled in a gap between the magnet and the magnet hole,
the second resin part is made of a same material as the first resin part.

9. The rotor according to claim 1, wherein the rotor core fastening member is made of a glass fiber-reinforced resin.

10. A method of producing a rotor comprising:
fastening a rotor core to a shaft, wherein the rotor core is comprised of a plurality of magnetic steel sheets stacked in an axial direction of the rotor, and includes a center hole; a magnet hole arranged radially outside of the center hole; and a resin hole arranged radially outside of the magnet hole, wherein the rotor core is fastened to the shaft by fitting the shaft into the center hole;
inserting a magnet into the magnet hole of the rotor core; and
pouring a resin into the resin hole of the rotor core and a gap between the magnet and the magnet hole.

11. The method according to claim 10 further comprising introducing a resin on an end face of the rotor core in the axial direction after the step of pouring the resin, so as to connect the resin filled in a first resin hole and other resin filled in a second resin hole adjoining the first resin hole in the circumferential direction, on the end face of the rotor core in the axial direction.
